(19) United States
(12) Patent Application Publication
(10) Pub. No.: US 2011/0229710 A1
(43) Pub. Date: Sep. 22, 2011

(54) METHOD FOR PROTECTING COMPOSITE STRUCTURES AGAINST IMPACTS

(75) Inventors: Bruno Desmars, Saint Medard En Jalles (FR); Sylvain Berard, Saint Chaxas (FR)

(73) Assignee: ASTRIUM SAS, Paris (FR)

(21) Appl. No.: 13/001,761

(22) PCT Filed: Jun. 29, 2009
(86) PCT No.: PCT/EP09/58119

§ 371 Date: May 13, 2011

(30) Foreign Application Priority Data
Jul. 4, 2008 (FR) 08 54568

(51) Int. Cl. B32B 5/18; B32B 15/06; B32B 25/16; B32B 25/04; G01N 3/30

(52) U.S. Cl. 428/318.4; 73/12.01

(57) ABSTRACT

An impact-resistant protective coating includes a material consisting of an outer metal adhesive layer having a sub-layer of compressible cellular material.

### CROSS-REFERENCE TO RELATED APPLICATIONS

This application is the National Stage of International Application No. PCT/EP2009/058119 International Filing Date, 29 Jun. 2009, which designated the United States of America, and which International Application was published under PCT Article 21 (s) as WO Publication No. WO2010/000701 A1 and which claims priority from, and the benefit of, French Application No. 08 54568 filed on 4 Jul. 2008, the disclosures of which are incorporated herein by reference in their entireties.

The aspects of the disclosed embodiments relate to a method for protecting structures, especially those made of composite materials, against impacts.

### BACKGROUND

Such protection is important for such materials since damages such as delamination caused by impacts on the structures made of composite materials cannot be seen easily.

The protective method pursuant to the aspects of the disclosed embodiments depends on each application, since in fact the behavior of the composite material on impact depends on its physicochemical nature, its intrinsic mechanical properties, and its geometry.

For each application, the aspects of the disclosed embodiments permit finding an optimal solution in terms of protection against impacts and of the extent of protection.

The document FR 2 861 847 relates to the behavior of materials on impact and the detection of these impacts.

The impacts considered in this document are low-energy and low-speed impacts that are customarily encountered in industrial practice: an object such as a hammer falling on a structure, for example, is the typical example of such impacts.

These impacts are called low-energy and low-speed impacts since the energy of the objects that strike the structure is less than one hundred joules, and the speed is less than 5 m/s, in contrast to high-energy impacts like those due to firearm projectiles where the unit is at least a kilojoule.

From the physical phenomena point of view these impacts are very different: Low-energy impacts correspond to quasi-static phenomena like those encountered in conventional tensile/compression tests. These impacts can cause deformations of materials and their degradation, for example by causing delaminations (decohesion) between the different layers of fibers of composite materials.

High-energy impacts set in motion shock wave effects, and can lead to breakdowns or piercing of materials.

Impact tests for low-energy impacts on specimens were standardized in the AITM Standard 1.0010. The tests are performed on 150×100 mm plates with the impact tool whose principle is described in FIG. 1.

The support for the specimen is described in FIG. 2, which shows a tool and an impact specimen in the sense of the AITM standard.

The fall height and the weight of the impactor permit defining the desired energy of the impact to be applied.

The consequences of the impact are determined by ultrasound examination of the material after tests, which reveals faults and in particular delaminations of the composite materials due to the impacts.

It is known that composite structures, in particular those based on carbon fibers, are sensitive to impacts such as falling tools, impacts in use or others, at the same time because of the damages that they cause but also because these impacts are not always detectable.

This sensitivity leads to the adoption of protective measures during the manufacture or installation of these structures, or even in use. This is a more challenging than it would seem since the problem is complex because of the fact that the protection has to effectively protect against impact, in other words impede the degradation of the substrate that it protects, it has to permit the occurrence of an impact to be detected, and it must be compatible with its use on the actual parts, and accordingly on the one hand compatible with complex geometries and on the other hand it may have to be provided with simple detachable fastening systems.

Moreover, such guards must be as lightweight as possible, especially when they are left in place on the parts to be protected because of the fact that since in general the benefit of using composite materials is to make particularly lightweight parts, it is a matter of not countering this benefit by increasing the weight.

This is particularly important in the aerospace sector, for which the large dimensions of the composite parts made impose minimizing the weight of the guard so as to simplify the assembly/disassembly operations.

The solutions utilized up to now such as covering parts with flexible cellular materials arranged and shaped directly on the structures are only very slightly effective in terms of impacts of the dropped tool type. Putting these solutions in place is not always easy for structures with large dimensions, for example tanks, when making attachment systems at the bottom of the tank.

Guards based on much more dense cellular materials that lead to better efficacy exist, but they have the drawbacks of being rigid and very fragile, which makes them unfavorable for use in mass production.

There are also external thermal guards made of Norcoat cork, Norcoat being the trade name of a commercial product from the ASTRIUM Company that is cemented to various composite structures. These guards also have good properties in terms of impact resistance, but they have the drawback of being relatively stiff; this makes them incapable of functioning as a reusable, removable antishock guard, thus without being cemented, from the point of view of mass production.

A single commercial product has finally been identified as having an interesting industrial potential: it consists of a family of shock-absorbing viscoelastic elastomers sold under the name SMACTANE by the French SMAC Company and a sheet of aluminum, and has excellent efficacy in the field of impacts being discussed, since it allows shifting of primary damage to above 80 J.

However, the density and the significant rigidity of this product are a hindrance to its use on structures with large dimensions or to small-radius curves (problem of compatibility of the mechanical protection with the geometry of the part to be protected).

Also in the domain of protecting structures is the document FR 2 869 871, which describes covering edges of composite structures made up of superimposed layers with U-style edge moldings to protect the edges of such parts against impacts in the range of 35-90 joules, and to reveal the presence of impacts.

To make the edge moldings, this document describes using a closed-cell synthetic foam, a rigid foam, that can be covered with a glass protective film or a film of poly(para-phenylene terephthalamide) known by the trade name Kevlar.

A rigid foam is suitable for the intended application, since the edges generally have a simple geometry.

On the other hand, such a foam is not suitable for complex surfaces since it is not deformable.

The document FR 2 860 565 describes protecting either permanently or temporarily a part that has a core principally of the monolithic or sandwich type by a complex surface covering made up of an elastomer clad with a rigid protective layer of a metallic material, organic composite, or mixed rigid metallic/composite as the case may be.

The elastomer-based structure described remains solid and the elasticity of the elastomer makes it difficult to detect impacts.

The document FR 2 771 331 relates to the same problem applied to parts of structural elements of an aircraft, but the solution proposed consists of including a superficial metallic fabric in the composite part.

From this prior art, it is found that a number of types of solutions proposed for protecting parts against impacts are of a single material while others are duplex.

The duplex solutions according to the prior art comprise an elastomer and a metallic or composite covering.

These solutions are still onerous and heavy, with the elastomers also making it difficult to detect impacts because of their incompressibility, which opposes the deformation of the metallic sheet covering them.

### SUMMARY

Finally, it is necessary to specify more precisely the phenomena in play and to develop new methods that are effective in terms of impact resistance and that are compatible with the constraints of industrial utilization.

Thus the objective of the aspects of the disclosed embodiments is to define an antishock protective system compatible with industrial utilization, to with:
efficacy of the mechanical protection to minimize the risks of degradation of the structures, providing resistance to a dropping tool with energy greater than 50 joules for a weight as low as possible;
a capability of detecting the occurrence of impact, which permits fast inspection of the state of the structure in case impact is detected a posteriori;
ease of use on parts, both in terms of geometry and in terms of simplicity of placement.

To this end, the disclosed embodiments propose antishock protection characterized in that it comprises a material composed of an outer metallic layer adhering to an underlay of compressible cellular material.

More specifically the material of the underlay is a material that is compressible by plastic deformation.

The antishock guard of the disclosed embodiments is accordingly a duplex material composed of an outer metallic layer adhering to an underlay of compressible cellular material.

The disclosed embodiments also relate to a method for optimizing the protection of a part, characterized in that an antishock protective covering is determined that has an outer metallic layer adhering to an underlay of compressible cellular material with plastic deformation, by the following steps:
determination of the stiffness of the metallic layer to substantially augment the surface involved in the impact;
determination of the thicknesses of the metallic layer and of the layer of compressible cellular material so that the deformations of the covering do not transmit the forces to the protected part, depending on the maximum impact required;
adaptation of the covering so that the plastic behavior of the covering permits the detectability of the impact on the one hand, and the dissipation of the incident energy on the other hand.

### BRIEF DESCRIPTION OF THE DRAWINGS

Other characteristics and benefits of the disclosed embodiments will be apparent from reading the following description of a non-limiting example of embodiment of the disclosed embodiments, with reference to the Figures, which show:

FIG. 1: a schematic side view of an impact test device;

FIG. 2: a device to hold a test specimen;

FIG. 3: a curve showing the growth of damage as a function of the impact energy;

FIG. 4: a curve showing an indentation test on a guard with no composite substrate;

FIG. 5: a table recapitulating a plurality of protective materials tested;

FIG. 6: a curve showing the curves representing force as a function of energy on indentation tests with the protective coverings using the materials of FIG. 5;

FIG. 7: curves of impacts on a thin composite substrate;

FIG. 8: curves of impacts on a thick composite substrate.

### DETAILED DESCRIPTION

The concept of the duplex covering of the disclosed embodiments rests on the following principles:
the impact must be distributed over the largest possible area, by using a rigid metallic material;
the cellular material must be sufficiently compressible to support the deformations of the covering without transmitting the forces to the protected composite;
the plastic behavior of the covering permits the detectability of the impact on the one hand, and also contributes to the dissipation of the incident energy.

To perform these functions, the disclosed embodiments are based on a light foam that is crushed under impact and has very low elasticity to prevent pushing back the metallic layer after the impact, which would reduce the impact detection capability of the covering.

The foam is preferably an open-cell foam.

The possibility of industrial use that is obtained is linked to the use of a duplex flexible material with little fragility put to use by the nature, thickness, stiffness, and ductility of the metallic sheet, by the nature, suppleness, density, and thickness of the cellular material, which are optimized to obtain the lowest possible weight for the expected shock protection.

The disclosed embodiments are applied initially to the protection of any composite part in storage.

It can obviously be extended to any composite part in use, and the low weight of the protective covering of the disclosed embodiments then takes on even greater importance.

It can also be extended to the protection of any fragile part, whatever its material, metallic, ceramic, or glass.

Moreover, the protective covering also provides scratch protection and accordingly protection in the case of mixed scratching/impact.

To better understand the nature of the disclosed embodiments, it is necessary to know what happens when a composite material is impacted, and in particular the energy threshold of degradation by impact.

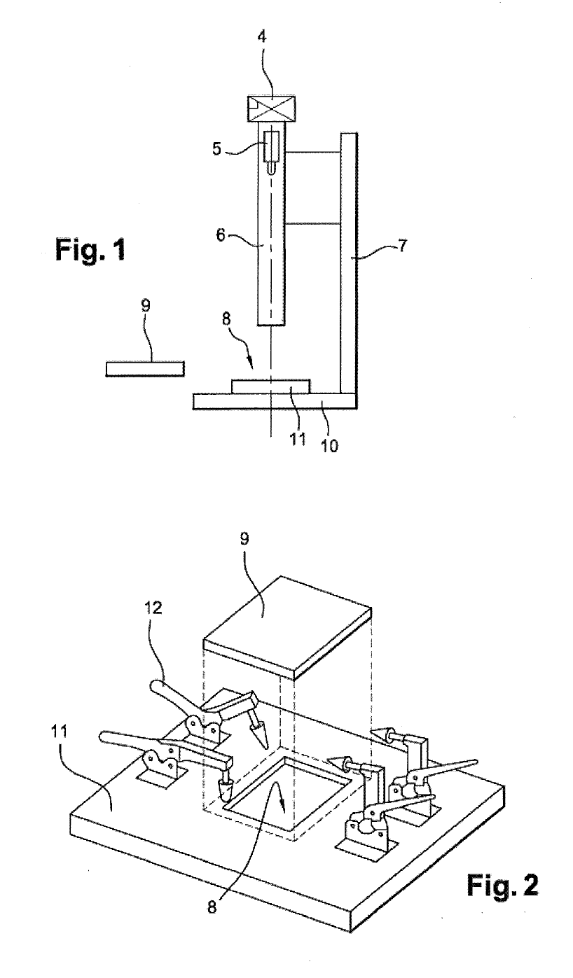

To perform the impact tests a standard tool shown in FIG. 1 is used.

This tool has an electromagnetic actuator 4 that can release a projectile 5 with a hemispherical impact end traveling in an impact tube carried by a support frame 7, 10. The specimen 9 of the material to be tested is arranged on a framework 11 that has an initialization window 8.

The arrangement of the specimen 9 on the framework 11 provided with the window 8 is shown in FIG. 2.

The specimen is kept centered on the framework 11 by supports and blocks 12 called grasshoppers. The framework 11 is heavy to oppose a strong reaction force on impact.

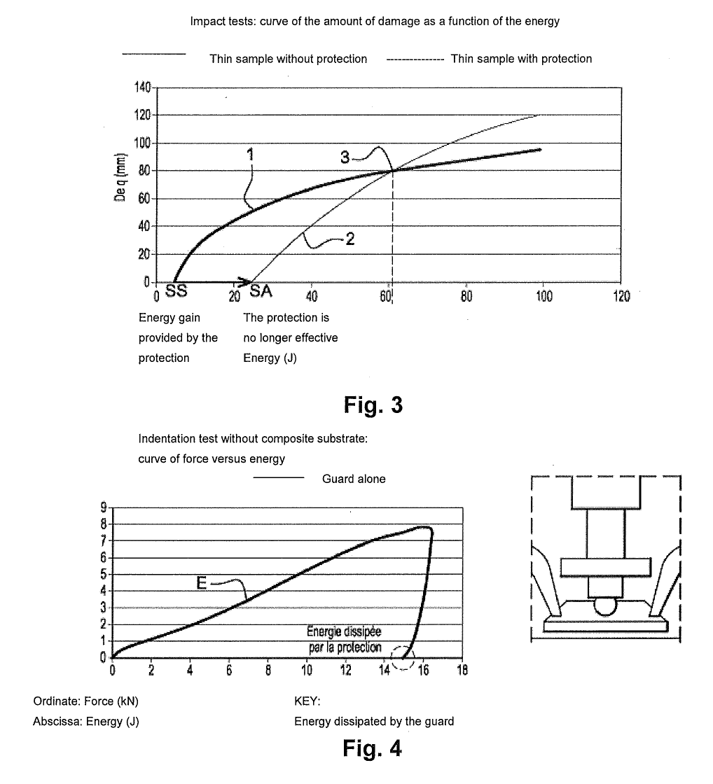

FIG. 3, which shows the relation of the magnitude of damage as a function of energy, shows the type of result that is obtained when a material embodied by a thin sample, covered or not by a guard, is impacted with various energies.

Curve 1 corresponds to an unprotected material and the damages begin to be apparent with an energy SS.

Curve 2 corresponds to the material with a protective covering and the damages begin to be apparent with an energy SA.

The point of intersection 3 of Curves 1 and 2 corresponds to the energy at which the protection is no longer effective.

The amount of material degraded, expressed as the average diameter of the circle degraded Deq, is plotted on the ordinate axis, with the abscissa axis representing the impact energy.

It is found first of all that the composite material is degraded only above a threshold, a minimum energy threshold SS, which signifies that below this energy the part retains its nominal mechanical properties, no longer tested by inspection but by appropriate mechanical tests.

It is then found that a guard may raise the energy threshold SA beyond which the material is degraded.

The efficacy of a guard will then be quantified by the gain of this energy ΔJ, in other words the difference SA-SS.

It should also be noted that these thresholds depend on the geometry of the specimens tested, their radius of curvature, and especially on their thickness.

For a flat specimen of the T800 carbon fiber type from the Toray Company and epoxy resin 7 mm thick (thin sample in the following text), the SS threshold as shown in FIG. 3 is 5 joules, while for the same material with a thickness of 14 mm (thick sample in the following text), the SS threshold rises to 45 joules.

From the phenomenological point of view, when it is desired to protect a material against an impact, the question arises of knowing where to expend the energy of the impact. The first idea for minimizing the impact energy able to be dissipated in the material to be protected is to try to have this energy absorbed by the guards.

Tests have been made to quantify this solution. To do this, compression tests were carried out on various materials intended for making a protective layer. These were quasi-static compression tests performed on a conventional tensile tester with a 16-mm ball representing the diameter of the impactor.

The tests correspond to a load/unload performed by crushing a sample of the material placed on a very rigid substrate up to a compression equal to 95% of the initial thickness of the sample.

The force/deformation curve is used in a special way: the behavior curve of the material is integrated during the test, which permits accessing the energy absorbed by the material. The force applied is then plotted on a curve versus the energy absorbed. At the end of the test, the specimen is unloaded, which gives access to the maximum energy absorbed by this material.

FIG. 4 shows the curve of force versus energy in an indentation test on the material intended to make up the protective layer in contact with the product to be protected not covered by the sheet metal.

This Figure defines a general curve E that will be found in the particular components tested by this method.

Various materials were provided, for which the following characteristics were required:

thickness variable between 5 and 20 mm,

density less than one,

εR ultimate elongation>5%, σR failure stress>2 MPa,

Compression stress at 10% deformation>0.5 MPa,

Compression stress at 50% deformation>6 MPa,

Compression stress at 80% deformation>100 MPa.

All of this so as to have a material capable of absorbing energy with a minimal weight.

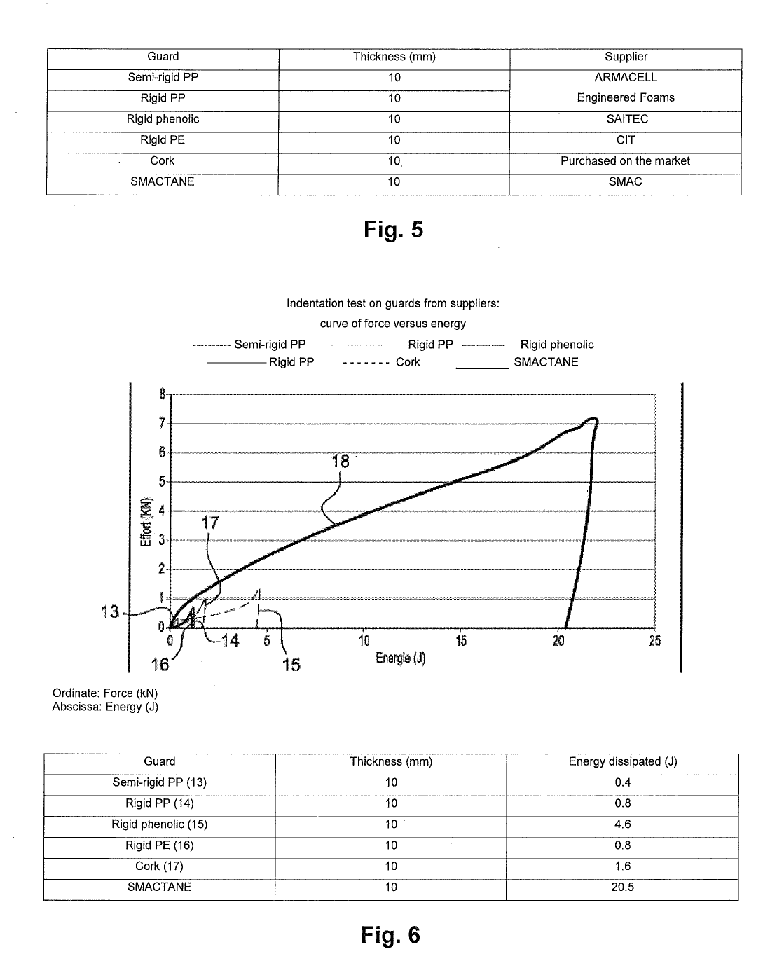

FIG. 5 shows a table for different test materials. PP is the abbreviation for polypropylene, and PE is the abbreviation for polyethylene.

The results of the materials tests are shown in FIG. 6, in which the curve of force versus energy has been reported for the various materials tested by the method described above.

In increasing order of force versus energy are semi-rigid polypropylene 13, rigid polyethylene 16, rigid polypropylene, cork 17, rigid phenolic resin 15, and Smactane 18, with the later comprising an elastomer combined with an outside metallic layer.

It was found that the energy dissipated in the material was very little, much below what was needed. The SMACTANE, however, had a more favorable behavior, but this material actually has a very high density of the order of 1.3, which disqualifies it for industrial use where low-weight protection is wanted.

The obvious conclusion from these tests is that the materials tested do not have sufficient energy-absorbing capacity to provide an impact absorption function without being too heavy, and accordingly that the elastic underlay solution turns out to be a method that is not optimal and not very usable.

Furthermore, these tests showed drawbacks present in some of these products, in particular the rigid foams are fragile, they crumble, they are difficult to utilize for complex geometries, and they have short service lives in industrial environments.

It is also found that the material of the bottom layer cannot provide protection if it is not dense enough, which leads to an impasse if minimal weight is wanted for the protection.

To avoid recourse to a dense material, the disclosed embodiments start with the principle that to avoid the deterioration of a composite substrate, the local energy level must not exceed the impacts permitted by the material.

To this end, the disclosed embodiments provide for spreading out the area of the material exposed to the impact as much as possible while preventing the impact from reaching the material.

The solution consists of a product comprising two materials linked together, for example by cement, and including an outside layer as rigid as possible which is intended to spread out the area involved in the impact as much as possible, and an underlay that is very easy to crush, which is intended to permit absorption of the deformation of the outside layer, and whose thickness is sufficient for it not to be completely crushed under the impact.

The resulting product is optimized with regard to its weight as a function of the maximum envisioned impact energy, as a function of the thickness of the composite substrate to be protected, and as a function of the suppleness desired for the ensemble depending on the geometry of the part to be protected.

By way of example, it is considered that in an industrial environment the probability of the energy of impacts due to dropped tools exceeding 50 joules is very low.

A guard accordingly must permit the part to be protected to resist such an energy, and must permit detection of an impact beyond that in any event.

Moreover, other requirements can be taken into account. In particular, an outer layer that also has high plasticity will also allow making the impact evident because of the impression that will have been produced during the impact.

In further detail with regard to the rigidity of the outer layer, to spread out the area involved in the impact to the maximum, the deflection of the outer layer subjected to the impact has to be reduced.

This deflection is inversely proportional to the inertia I of this covering, with this inertia itself being proportional to the modulus E of the material used and to the cube of the thickness e of this layer (I=K*E*e3).

Reducing the deflection accordingly implies increasing the modulus and the thickness of this layer. But to optimize this layer with regard to weight is to choose a material that has the highest specific modulus (modulus divided by the density of the material) while minimizing the thickness of the layer.

Aluminum and its alloys, well known in aeronautics for their high specific moduli, are imposed for this layer.

For the detectability of the impact, the alloys of aluminum chosen from those that are available are those that have a high ultimate elongation and high plasticity to significantly increase the area affected by the impact.

Because of this, the outside layer will be significantly deformed at the point of impact and will retain an impression of the impact. This plastic deformation of the outside layer will also contribute to the absorption of the energy of impact. A substantial distribution of the impact over the surface of the outside layer is thus obtained.

It should be noted that a layer of composite material would not be suitable for this function, since this type of material has no plasticity. On the contrary, a composite material may have a very high specific rigidity.

A conventional paint system for detecting impacts known by the trade name aerodex, or pressure-sensitive films like those known by the trade name PRESSUREX can be used as a supplement to improve the detectability of the impact.

The outside layer being chosen with a relatively high modulus, the only way to impart relative suppleness to the covering is for the outside layer to have the smallest possible thickness. This objective is attained simultaneously with the optimization of the weight of the covering.

In the same way, the underlay will also have to be supple, so that the rigid foams are to be avoided and the disclosed embodiments are based on supple foams, for example of the elastomeric type.

The principal function of the underlay is its ability to be crushed: it should be maximized, keeping in mind that crushing of 95% is acceptable.

An index of protection efficacy Ef can be defined as the ratio between the energy gain ΔJ mentioned above and the basis weight of the guard:

Ef=ΔJ/(eSC*ρSC+ec*ρc)

eSC, ρSC represent respectively the thickness and the density of the underlay;

eC, ρC represent respectively the thickness and the density of the outside layer.

The preferred solution is composed of an outside layer of aluminum alloy 2024 T3, whose properties are given below.

| Alloy | Density | E | R02 | Rm | A % |
|---|---|---|---|---|---|
| 2024-T3 | 2.78 | 72400 | 290 | 440 | 14% |

The underlay is a neoprene foam with a density of 160 kg/m3, with a crush capacity of 95%.

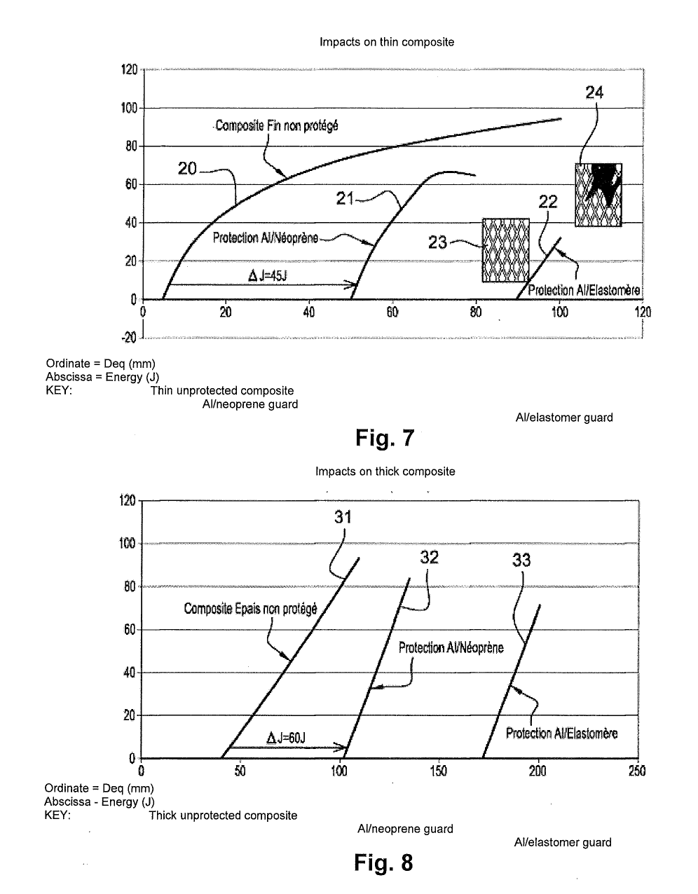

FIGS. 7 and 8 describe the results obtained with two types of composite materials, thin (7 mm) and thick (14 mm).

For each material, the following data were plotted in FIG. 7, corresponding to a representation of impacts on thin composites:
the behavior of the composite alone, in Curve 20,
the behavior with a guard left on, composed of 1 mm of 2024 T3 alloy cemented by silicone to a neoprene foam 9 mm thick with a density of 160 kg/m3, in Curve 21,
the behavior with a guard made up of 1 mm of 2024 T3 alloy cemented by silicone to an elastomer with a density of 1250 kg/m3 (commercial Smactane).

It is found that the guard combining an outside metallic aluminum layer adhered to an underlay of cellular foam compressible by plastic deformation, in other words a material that is crushed under force with very little elastic rebound, in particular a rebound of less than 5% when the force is released, is perfectly suitable.

According to the disclosed embodiments, the foam is adjusted to obtain a high proportion of plastic deformation, particularly greater than 90%, at the end of the range of impacts considered, with the crushing of 0 to 90% being obtained in the range from 0 to 50 joules or to 100 joules, depending on the application considered and the impacts against which the composite structure is to be protected.

For the range of impacts considered, the underlay is also designed so that its deformation does not reach its limit of incompressibility, leading to a transfer of energy between the metallic layer and the protected part.

Specifically, the material of the underlay is determined and it is designed so that for the range of impacts considered, its deformation does not lead to contact between the metallic layer and the protected part, for example by tearing of the underlay.

The ultrasound images of the composite are also shown as a function of the impacts, and the image 23 depicted corresponds to a composite unchanged by the impact, for energy below 5 joules for the unprotected composite, energy below 50 joules for the composite protected according to the disclosed embodiments, and energy of 90 joules for the composite protected by a guard using the material known by the name SMACTANE.

The image 24 depicted corresponds to an equivalent diameter of 60 mm, for energy of the order of 30 joules for the unprotected material, energy of 70 joules for the material protected according to the disclosed embodiments, and energy of the order of 100 joules for the material protected by the guard using SMACTANE.

FIG. 8 corresponds to a representation of impacts on thick composites, and the curve 30 corresponds to the behavior of the composite alone, 31 to the behavior of the composite with the protection left on for the product of the disclosed embodiments described above, 32 to the behavior with the guard made up of 1 mm of alloy 2024 T3, cemented by silicone to an elastomer with a density of 1250 kg/m3, and a thickness of 9 mm.

The positive effect of the two guards is found; they move the starting point of degradation of the protected product up to 50 joules for the guard of the disclosed embodiments and a thin composite according to FIG. 7, and up to 90 joules for the guard using an elastomer, while for a thick composite the guard of the disclosed embodiments shifts the starting point of degradation to beyond 100 joules, as shown in FIG. 8.

It is also found that the protection based on “heavy” elastomer is more effective, but the Al/elastomer guard weighs 14 kg/m2 while the Al/neoprene foam guard weights 4.2 kg/m2.

In terms of the index E_{f} as defined above, the index of the Al/neoprene foam guard pursuant to the disclosed embodiments varies between 11 and 15 depending on the material protected, and that of the Al/elastomer guard varies between 6 and 9, which expresses well the lesser efficacy by weight of the Al/elastomer guard.

This confirms the validity of the principle of the disclosed embodiments of using for the underlay an inelastic material that is crushed under impact and has high compressibility by plastic deformation.

1. Antishock protective covering, comprising a material made up of an outside metallic layer adhering to an underlay of cellular compressible material.

2. Antishock protective covering pursuant to claim 1, wherein the underlay of cellular material comprises a material compressible by plastic deformation.

3. Antishock protective covering pursuant to claim 1, wherein the underlay of cellular material comprises a foam.

4. Antishock protective covering pursuant to claim 3, wherein the underlay of cellular material comprises a flexible foam.

5. Antishock protective covering pursuant to claim 3, wherein the underlay of cellular material comprises an open-cell foam.

6. Antishock protective covering pursuant to claim 1, wherein the underlay of cellular material is a neoprene foam.

7. Antishock protective covering pursuant to claim 6, wherein the underlay comprises a neoprene foam with a density of 1600 kg/m3 that has a crush capability of at least 95%.

8. Antishock protective covering pursuant to claim 1, wherein the outside layer has a high modulus in order to spread out an impact.

9. Antishock protective covering pursuant to claim 1, wherein the outside metallic layer comprises a layer of an aluminum alloy.

10. Antishock protective covering pursuant to claim 9, wherein the outside layer of aluminum alloy is chosen from aluminum alloys with high ultimate elongation and high plasticity so that the outside layer is deformed to a major extent at a point of impact and retains an impression of the impact.

11. Method for optimizing the protection of a part, wherein an antishock protective covering is determined comprising an outside metallic layer adhering to an underlay of cellular material that is compressible by plastic deformation, wherein the antishock protective covering is optimized by:
determination of the rigidity of the metallic layer to increase substantially an area affected by an impact;
determination of the thicknesses of the metallic layer and of the compressible cellular material so that deformations of the covering do not transmit forces to the protected part, depending on a maximum impact required; and
adaptation of the covering so that a plastic behavior of the covering allows for detectability of the impact on the one hand, and for dissipation of incident energy on the other hand.

12. Method for optimizing the protection of a part pursuant to claim 11, wherein for a range of impacts, the underlay is designed so that deformation of the underlay does not reach a limit of incompressibility leading to a transfer of energy between the metallic layer and the protected part.

13. Method for optimizing the protection of a part pursuant to claim 11, wherein, for a range of impacts, the underlay is designed so that deformation of the underlay does not lead to contact between the metallic layer and the protected part.

14. Method for optimizing the protection of a part pursuant to claim 11, wherein the antishock protective covering comprises a foam adapted to obtain high degrees of plastic deformation.
